(19) United States
(12) Patent Application Publication
(10) Pub. No.: US 2008/0133342 A1
(43) Pub. Date: Jun. 5, 2008

(54) Determining Advertising Effectiveness

(76) Inventors: Nathalie Criou, San Francisco, CA (US); Hal R. Varian, Danville, CA (US); Michael M. Meyer, Seattle, WA (US); Edward A. Miner, Mill Valley, CA (US); Ken Harrenstien, Palo Alto, CA (US)

Correspondence Address: FISH & RICHARDSON P.C., PO BOX 1022, MINNEAPOLIS, MN, 55440-1022, US

(21) Appl. No.: 11/566,143

(22) Filed: Dec. 1, 2006

(51) Int. Cl. G06Q 30/00

(52) U.S. Cl. 705/14

(57) ABSTRACT

Systems, methods, and apparatus including computer program products are provided for determining advertisement effectiveness. In some implementations a method is provided. The method includes identifying a plurality of user events, where each user event is a tracked online activity or action and identifying information associated with each identified user event, the information including at least one of a time and a location of each user event. The method also includes associating each user event with an advertisement including relating each advertisement with times and locations of associated user events and determining advertisement effectiveness using the information from the identified plurality of user events.

### BACKGROUND

The present disclosure relates to advertising.

Advertisers provide advertisements in different forms in order to attract consumers. An advertisement is a piece of information designed to be used in whole or part by a user, for example, a particular consumer. Advertisements can be provided in electronic form. For example, online advertisements can be provided as banner advertisements on a web page. Offline electronic advertisements can be provided by media sources including television or radio (e.g., commercials), along with content in compact disks or digital versatile disks, as well as by electronic billboards (e.g., in elevators, airports, and along roadways).

One can refer to the inclusion of an advertisement in a medium, e.g., a webpage or a television or radio broadcast, as an impression. An advertising system can include an advertisement in a webpage, for example, in response to one or more keywords in a user search query input to a search engine. If a user selects the presented advertisement (e.g., by “clicking” the advertisement), the user is generally taken to another location associated with the advertisement, for example, to another, particular web page.

### SUMMARY

Systems, methods, and apparatus including computer program products are provided for determining advertisement effectiveness. In general, in one aspect, a method is provided. The method includes identifying a plurality of user events, where each user event is a tracked online activity or action and identifying information associated with each identified user event, the information including a time and a location of each user event. The method also includes associating each user event with an advertisement including relating each advertisement with times and locations of associated user events and determining advertisement effectiveness using the information from the identified plurality of user events.

In general, in another aspect, a method is provided. The method includes collecting data from online user events, the user event data including a time of each user event, where each user event is a tracked online activity or action and identifying advertisements in offline media. The method also includes collecting advertisement data from the identified advertisements, the advertisement data including a respective time when each respective advertisement was presented and determining an effectiveness of one or more advertisements using the user event data and the advertisement data.

In general, in one aspect, a system is provided. The system includes means for identifying a plurality of user events, where each user event is a tracked online activity or action and means for identifying information associated with each identified user event, the information including a time and a location of each user event. The system also includes means for associating each user event with an advertisement including relating each advertisement with times and locations of associated user events and means for determining advertisement effectiveness using the information from the identified plurality of user events.

Particular embodiments of the subject matter described in this specification can be implemented to realize one or more of the following advantages. Advertisers can track the effectiveness of advertisements both online and offline. Effectiveness of offline advertising can be inferred from monitoring online activity. Advertisement effectiveness can be assessed as a function of both location and time. Advertising costs can be reduced by test marketing advertisement campaigns in localized areas and identifying effective advertising, which can then be deployed more broadly. Online measures of ad effectiveness can be generated quickly and inexpensively and, since they can be provided in machine readable form, can be easily manipulated and correlated with other measurements. Additionally, advertisers can use marketing or advertising money more effectively by improving advertising campaigns to target areas or times where the advertising message is more effective.

The details of the various aspects of the subject matter described in this specification are set forth in the accompanying drawings and the description below. Other features, aspects, and advantages of the subject matter will become apparent from the description, the drawings, and the claims.

### BRIEF DESCRIPTION OF THE DRAWINGS

FIG. 1 shows an example process for using locations and times associated with online activity to determine advertising effectiveness.

FIG. 2 shows an example process for determining effectiveness of offline advertisements.

FIG. 3 shows an example display of online activity over time.

FIG. 4 shows an example of a hardware architecture that can implement the processes shown in FIGS. 1 and 2.

FIG. 5 is a block diagram of an example advertising system.

Like reference numbers and designations in the various drawings indicate like elements.

### DETAILED DESCRIPTION

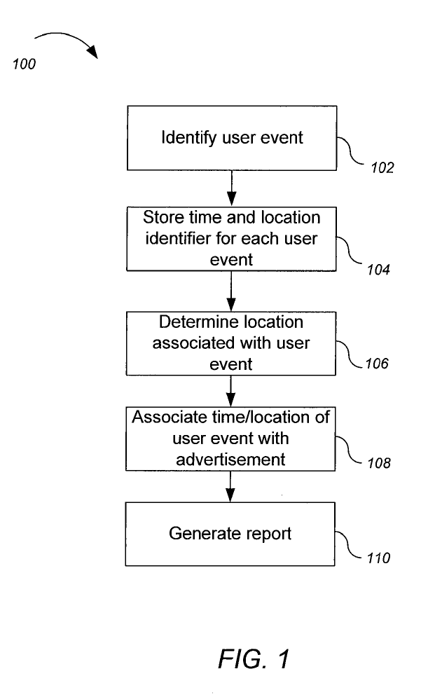

FIG. 1 shows an example process 100 for using data, including a time or location, associated with online user activity to determine advertising effectiveness. For convenience, the processes will be described with reference to a computer system that performs the process 100 (e.g., an advertising system).

The system identifies a user event (step 102). As used in this specification, the term user event refers to any online activity or action tracked by the system. In some implementations, user events are events resulting from user activity on a computer or other device connected to a network such as the Internet.

For example, the user event can be a query event. A query event is a search requested (e.g., by a search engine) according to a user specified search query. The user can use a browser application to access a search engine. After providing one or more search terms into a search field as a search query, the user can select a search button to request a search according to the search query. The search engine then presents matching search results to the user (e.g., as an ordered list of results). The search results can be links to destination web pages.

The user event can be an impression event. In one embodiment, an impression event is the inclusion of a particular advertisement in a medium, e.g., a webpage, a television or radio broadcast, or a video. For example, one or more advertisements can be included in a web page along with the search results. Additionally, different content providers, e.g., the providers of particular web pages, can provide advertisements along with the particular content of the web pages.

In some implementations, each advertisement is associated with one or more keywords. When the user's search query matches one or more of the keywords associated with the advertisement, the advertisement can become eligible for presentation to the user. Among a set of eligible advertisements, an auction process can be performed to select a particular advertisement. Other factors can also be used to determine which advertisement to present. An advertiser can designate other demographic or geographic properties as factors used in choosing a given advertisement for presentation. For example, the advertiser can prioritize particular locations of the user or the times of day for an advertisement, thus targeting advertisement presentation.

The user event can also be a “click” event. A click event is a user selection of a presented advertisement. For example, for advertisements presented along with search results, the user can select an advertisement by clicking on the advertisement with their mouse or other input device. In some implementations, when a user selects an advertisement, the browser directs the user to a particular web page associated with the selected advertisement (e.g., a landing page).

In some implementations, click events can include other forms of user input. For convenience these activities are also referred to as click events, although they can involve various forms of user input. For example, in some implementations a telephone call or email can be generated when the user selects an advertisement. The click event can refer to one or more verbal responses or key presses by the user in response to the generated telephone call or email. Additionally, click events can also refer to forms of user input including a mouse over or other input for interacting with an advertisement.

When a user event is identified, the system collects a time and location identifier associated with the identified user event (step 104). The time of each user event can be ascertained according to a user action. For example, the time of the query event can be defined as the time when the user initiated the search (e.g., by clicking a “search” button). The time for the impression event can be the time in which an advertisement was included in a medium, e.g., a webpage, while the time of the click event can be the time when an advertisement is selected by the user (e.g., by clicking the advertisement). An advertising log used by an advertising system can record the time in which an advertisement is presented to a user as well as the time at which a selection of an advertisement occurs (e.g., for use in advertising billing records). Other contextual information can also be recorded. For example, if the user is browsing a particular piece of content when the advertisement click occurs, that information can also be recorded.

The location identifier is data that can be used to determine the user's location. The location identifier can be data provided by the user's computer or an associated server (e.g., an internet service provider (“ISP”)) when the user accesses a network resource, e.g., a web page. For example, the location identifier can be an internet protocol (“IP”) address of the user. Other location identifiers associated with the user's connection to the network can be used, for example, a dial-in access number, or media access control (“MAC”) address.

Additionally, the location identifier can be user supplied geographic information, e.g., a city, zip code, or full address. For example, a user can provide information to one or more content providers. The user may provide a zip code to a content provider, for example, to receive localized content. Similarly, a user may provide information to a search engine in order to receive more tailored search results.

The system determines the user location using the location identifier (step 106). The level of resolution at which the location is determined can vary. For example, an IP address can be mapped to a geographic location (e.g., country, city, or service provider). A lookup table can identify a location using an area code or area code and prefix number of a dial-in access number. Additionally, the user-provided geographic information, e.g., a zip code, can be mapped to a particular location. This data may only provide an estimate the user's location. For example, a dial-in access number provides a location of a point of presence for a server providing access for the user (e.g., a dial-in ISP) and not the exact location of the user.

Techniques for identifying the location of the user are described in more detailed in commonly owned and co-pending U.S. patent application Ser. No. 10/654,265 “Determining and/or Using Location Information in an Ad System” filed on Sep. 3, 2003, which is incorporated here by reference in its entirety.

The system associates the time and location information of each identified user event with one or more advertisements (step 108). A database can be used to relate each advertisement with one or more user events associated with that advertisement. For example, for each query event, the query keywords can be matched to one or more advertisements associated with those keywords. Additionally, the time and location (e.g., an imputed user location) of each impression or click of an advertisement can be logged. Thus, each advertisement can be associated with data identifying the time and location of each user event associated with the advertisement. User events can be separately considered by type of user event. Alternatively, the user events can be aggregated for the advertisement.

The resulting data can be used to generate reports (step 110). For each individual advertisement, the reports can track user events by time, location, or both. The time period covered by the reports can vary according to a preference of the advertiser, or other criteria. Additionally, the report can break down the data for an advertisement according to the type of user event. Therefore, the data can be used, for example, to provide an indication of times or locations in which an advertisement is more effective (e.g., because the advertisement generates more queries, impressions, clicks, phone calls, or other user events).

Additionally, an advertiser can test the effectiveness of different online advertisements. For example, an advertiser can target different advertisements to particular locations such that the different advertisements will only be presented in particular locations. The data can then be used to determine which locations have a higher rate of click events, indicating which presented advertisement was more effective. Alternatively, the advertiser can target different advertisements to a same location. The reporting can then reveal which advertisements were more effective for that particular location. The advertiser can then test the advertisement in other locations or run a national campaign based on the localized data. Additionally, other advertisement variations e.g., advertisement text, images, color, and layout can be similarly tested.

The time of user events associated with an advertisement can also be used to test effectiveness. An advertisement can have a greater frequency of associated user events at particular times of the day. User events may be higher at a time when a targeted demographic is online. For example, advertisements targeting teenage consumers may have a greater number of user events in the evening. Advertisements can be targeted to particular times or periods of a day (e.g., morning, evening) based on the times in which they are likely to be more effective.

The advertiser can also test different keyword sets in different locations or applied at different times. Particular keywords can result in a greater number of associated user events. For example, particular keywords can be more likely to be used by a user in a search query, thus resulting in a greater number of associated user events. Sampling different keywords can identify an optimal set of keywords which will result in a high number of impression or click events. In particular, the number of click events can also be used to identify relevant keywords indicating a user interest in the advertisement. The optimal set of keywords can vary by location or time.

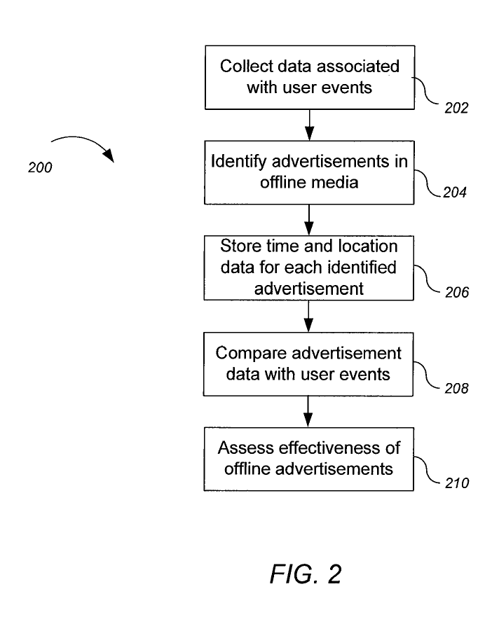

FIG. 2 shows an example process 200 for determining effectiveness of offline advertisements. The system collects data associated with online user events (step 202). As described above, user events can include, among others, query events, impression events, and click events. The collected data for each user event can include a time the user event occurred as well as the location of the user. In some implementations, the collected data is time and location data collected for user events as described above in reference to FIG. 1.

The system identifies advertisements in offline media (step 204). The offline media can include advertisements in several different forms. The advertisements can include television and radio commercials as well as electronic billboards or other electronic advertising. The advertisements in offline media can be transmitted to multiple individuals at the same time, for example, as part of a broadcast, cable, or satellite transmission to viewers and/or listeners.

Advertisements can also optionally include data that is not specifically identified as an advertisement. For example, an advertiser of a particular product can pay for placement of that product within a television program. An advertisement can therefore be a reference or use of the product in the television program (e.g., a character driving a particular model automobile or drinking a branded soda).

The advertisements shown in offline media can be arranged by an advertiser, e.g., by buying commercial airtime for particular commercial advertisements or product placement in particular offline media. The advertiser can create the advertisement, or more often, can employ a third party to create or place advertisements. An advertiser can target the offline advertisements to particular markets; however, the advertiser often has little control over the timing of the advertisement. For example, the advertiser typically does not know when a commercial advertisement will be broadcast on television.

Broadcast scheduling information can be used to identify when offline media advertising are presented. However, scheduling information is often inaccurate, incomplete, or only available after significant delays. In some implementations, for example in television, schedule files used, (e.g., by the television headends that receive and distribute television signals), to broadcast advertisements can be used to identify advertisement presentations. Additionally, the headend's records of which advertisements actually aired can be used to identify advertisement presentations.

In some implementations, the identification of advertisements in offline media includes monitoring closed caption streams for television channels. For example, each closed caption stream (or teletext e.g., in Europe) can be monitored for the occurrence of particular keywords. In some implementations, the keywords are one or more words from a commercial advertisement of the advertiser (e.g., a product name or one or more phrases from the advertising script). When a keyword is identified, a time stamp can be associated with an occurrence of the advertisement. In some implementations, when a keyword is identified more than once in a single advertisement, only a single occurrence of the advertisement is identified. Thus, the keywords identified in the closed caption stream can be used to identify the time and channel when a particular commercial advertisement is shown.

Additionally, television transmissions can vary by location or market. For example, different programming can be shown in New York than in Los Angeles. Television advertisers can base advertising buys on a Designated Television Market Area “DMA”, which signifies a region such as a city or metropolitan area associated with common television transmissions. For example, the Boston DMA includes not only Boston but a number of surrounding cities. One embodiment of a system according to the invention can monitor television transmissions broken down by DMA in order to distinguish different locations.

The closed caption stream can also be monitored to identify keywords associated with the advertiser from television media other than commercial advertisements, e.g., within a television program. For example, product placements can be identified by keywords in the closed caption stream of television programming (e.g., mention of brand name in television show).

In other implementations, other forms of monitoring can be used to identify advertisements. For example, television transmissions can include data in forms other than closed captioning. For example, some countries use teletext to provide services similar to closed captioning. Also, digital transmissions can include metadata that can be used to identify advertisements. Additionally, a speech-to-text application can be used or individuals can visually monitor programming to identify advertisements. Also, image recognition software can be used to identify advertisements in the television transmissions.

Advertisements can also be identified in radio broadcasts, including both land based and satellite radio. Radio advertising companies, e.g., dMarc Broadcasting, can schedule radio advertising by location as well as by daypart (e.g., morning drive, midday, evening, weekend). Additionally, the actual broadcast times for the radio advertisements are tracked. Consequently, the system can identify the time and location in which particular advertisements are broadcast by radio stations.

The monitoring to identify advertisements can be performed in real-time as the advertisements occur. Alternatively, transmission can be recorded for later analysis to identify advertisements.

The system stores data, which can include time and location data, for each identified advertisement (step 206). Thus, for each advertisement, a set of data can provide the time and location of each advertisement transmission. Additionally, the channel (or radio station) and programming where the advertisement is identified can be stored to provide additional information. For example, particular channels or programming target specific demographic groups.

The system compares the collected offline advertisement data with user events associated with the offline advertisements (step 208). The comparison can include identifying changes from historic levels in user events contemporaneous with the collected advertising data. For example, the comparison can identify whether query events containing particular keywords associated with an advertisement increase following an offline presentation of the advertisement. The comparison can be based on particular geographic locations. For example, a television advertisement in a particular DMA can be compared with a number of corresponding user events that occur within that same DMA.

The effectiveness of offline media can be assessed based on the comparison (step 210). One or more reports can be generated for an advertiser indicating when offline advertisements were presented and the corresponding levels of online user events. For example, if the advertisement presentation in offline media, e.g., a television commercial advertisement, induces an increase in user events over historical levels, such an increase may indicate that the advertisement is effective. In contrast, if the offline media does not significantly affect the user events, it can reveal that the advertisement did not generate a desired level of user interest.

In some implementations, an advertiser can test different offline advertising campaigns in one or more local markets to determine advertising effectiveness. Using the user activity associated with presentations of the test advertisements, the effectiveness of the offline advertisements can be determined. Additionally, the advertiser can identify whether or not one advertisement is more effective in one location than another, thereby selecting location specific advertising to maximize overall advertising effectiveness.

Advertising effectiveness can also be assessed in relation to the time between offline presentation and online user events. User events shortly after presentation can indicate a high level of user interest. User events later can also indicate the advertisement was very salient in being recalled by users at a later time. However, associating user events with a particular offline advertisement can become more difficult as the time to user events increases.

Additional information of advertising effectiveness can also be acquired. For example, in television advertising, commercials are generally broadcast with several other commercials in a commercial break. The placement of the commercial within the break (e.g., first, middle, last) can affect advertisement effectiveness. The system can record the position of the identified advertisement within a commercial break. Effectiveness of different positions in the commercial break can be assessed based on the user events associated with advertisements in different positions.

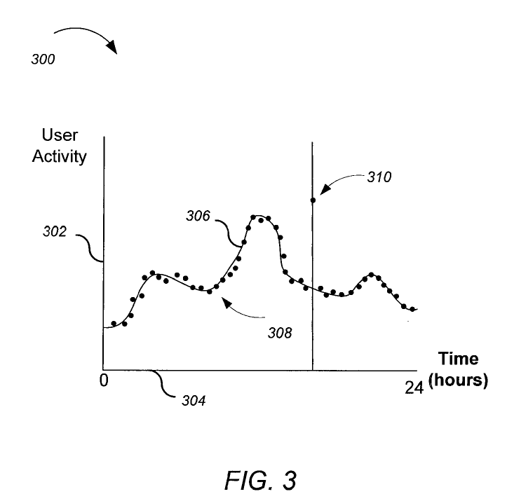

FIG. 3 shows an example display 300 of online activity over time associated with a particular advertisement. The display 300 plots user activity on a vertical axis 302 as a number of user events. The horizontal axis 304 displays a time range covered by the display 300. In this example, the horizontal axis covers the hours of a day from 0 to 24.

A history line 306 illustrates the historical level of user events associated with the advertisement during the same time period (e.g., the average daily breakdown of user events over a 24 hour period). A number of data points show the actual user events 308 for a particular day (e.g., reporting user activity of the previous day to an advertiser). As shown in display 300, the actual user events agree with the historical level of the history line 306 except for data point 310. Data point 310 indicates a spike in user events 308 at a particular time during the day. If the spike in user events shown by data point 310 correlates with offline advertising data, the offline advertising can be considered effective in generating user interest.

Other displays can be used to represent information regarding both user activity and offline advertising data (e.g., bar graphs, spreadsheets, etc.). Additionally, the displays can be focused to particular user events (e.g., just query events) as well as geographic location and particular time ranges (e.g., all user events in Chicago, or just query events in Chicago). A display can also include different forms of offline advertising events (e.g., data points for the airtimes of a commercial) to further illustrate any relationship between the offline advertising and the user events.

In some implementations, multiple advertisements of an advertiser can be assessed. A comparison can be made between advertisements, for example, among a series of test advertisements. For example, a histogram can show a number of user events for each of the advertiser's different advertisements. The advertiser can then determine which advertisement is more effective based on which advertisement is associated with more user events.

In some implementations, a central advertising system collects both online user activity and offline advertising data. The advertising system can process the collected data to determine advertising effectiveness or can provide that data directly to advertisers. The advertising system can collect the online user activity directly, but receive the offline advertising data from one or more third parties, which can include the advertiser itself. In alternative implementations, the advertising system provides the user activity data to a third party such as the advertiser and the advertiser compares offline data with the user activity to determine advertisement effectiveness.

In some implementations, advertisers can interact with one or more user interface components to identify preferences and receive advertisement effectiveness results. For example, an advertiser can access an account for the advertiser that includes one or more advertising campaigns. The advertiser can be presented with a number of menu selections for indicating the type of effectiveness data as well as the level of granularity. In some implementations, the advertiser can use a web based interface.

An advertiser can provide input requesting detailed reporting based on time and location. Consequently, the advertiser can then receive effectiveness results for an advertisement across a number of location and time periods (e.g., 200 cities on an hourly basis). Alternatively, the advertiser can specify particular locations or times, or both. Additionally, in some implementations, the user can select or specify the degree of granularity (e.g., daily, hourly, etc.).

In another example, the advertiser can receive partial results during an advertisement campaign, for example, when running experiments in particular markets (e.g., television advertisements running in particular cities). The advertiser can receive effectiveness results for those target cities with respect to time.

Additionally, the advertiser can request additional information about an advertising campaign (e.g., after an advertisement campaign has completed). For example, if the advertiser initially requested general effectiveness results, the advertiser can modify preferences to request additional detail (e.g., effectiveness results at a finer level of detail such as for particular cities and narrower time periods).

In some implementations, the advertiser preferences are provides through the user interface, but effectiveness reports are sent to the advertiser separately (e.g., a hard copy). Alternatively, however, the user interface can provide the effectiveness results to the user including activity displays such as shown in FIG. 3.

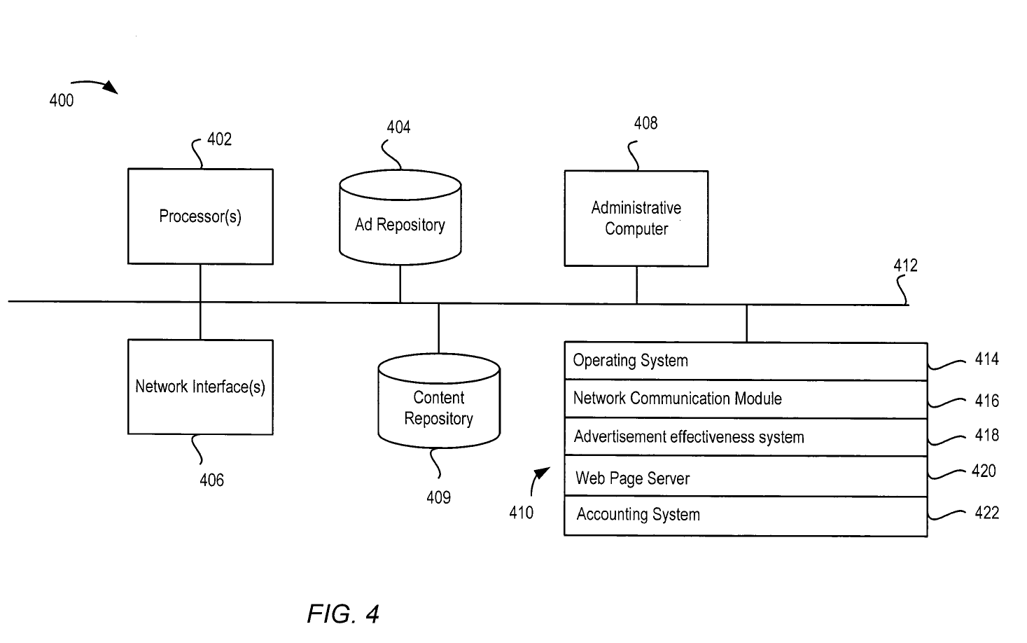

FIG. 4 shows an example of a hardware architecture 400 that can implement the processes shown in FIGS. 1 and 2. In some implementations, the architecture 400 includes one or more processors 402 (e.g., dual-core Intel® Xeon® Processors), an advertisement repository 404, one or more network interfaces 406 (e.g., including interfaces for receiving information on offline advertisements), a content repository 409 (e.g., for storing advertisement effectiveness data), an optional administrative computer 408 and one or more computer-readable mediums 410 (e.g., RAM, ROM, SDRAM, hard disk, optical disk, flash memory, SAN, etc.). These components can exchange communications and data over one or more communication channels 412 (e.g., Ethernet, Enterprise Service Bus, PCI, PCI-Express, etc.), which can include various known network devices (e.g., routers, hubs, gateways, buses) and utilize software (e.g., middleware) for facilitating the transfer of data and control signals between devices.

The term “computer-readable medium” refers to any medium that participates in providing instructions to a processor 402 for execution, including without limitation, non-volatile media (e.g., optical or magnetic disks), volatile media (e.g., memory) and transmission media. Transmission media includes, without limitation, coaxial cables, copper wire and fiber optics. Transmission media can also take the form of acoustic, light or radio frequency waves.

The computer-readable medium 410 further includes an operating system 414 (e.g., Mac OS® server, Windows® NT server), a network communication module 416 and an advertisement effectiveness system 418. The operating system 414 can be multi-user, multiprocessing, multitasking, multithreading, real time, etc. The operating system 414 performs basic tasks, including but not limited to: recognizing input from and providing output to the administrator computer 408; keeping track and managing files and directories on computer-readable mediums 410 (e.g., memory or a storage device); controlling peripheral devices (e.g., repositories 404, 409); and managing traffic on the one or more communication channels 412. The network communications module 416 includes various components for establishing and maintaining network connections (e.g., software for implementing communication protocols, such as TCP/IP, HTTP, etc.).

The computer-readable medium 410 includes an advertisement effectiveness system 418, which is responsible for providing the features and functions for determining effectiveness of online and offline advertising as described in reference to FIGS. 1-3. A web page server 420 is provided for generating the user interfaces described herein (e.g., for providing advertisers with advertisement effectiveness data). An accounting system 422 is provided for handling the accounting of payment schemes described herein (e.g., payments for advertising services).

The architecture 400 is one example of a suitable architecture for assessing advertisement effectiveness. Other architectures are possible, which include more or fewer components. For example, the advertisement repository 404 and content repository 409 can be the same storage device or separate storage devices. The components of architecture 400 can be located in the same facility or distributed among several facilities. The architecture 400 can be implemented in a parallel processing or peer-to-peer infrastructure or on a single device with one or more processors. The advertisement effectiveness system 418 can include multiple software components or it can be a single body of code. Some or all of the functionality of the advertisement effectiveness system 418 can be provided as a service to content providers, advertisers, and users over a network. In such a case, these entities may need to install client applications. Some or all of the functionality of the advertisement effectiveness system 418 can be provided as part of a search engine and can use information gathered by the search engine determine advertisement effectiveness.

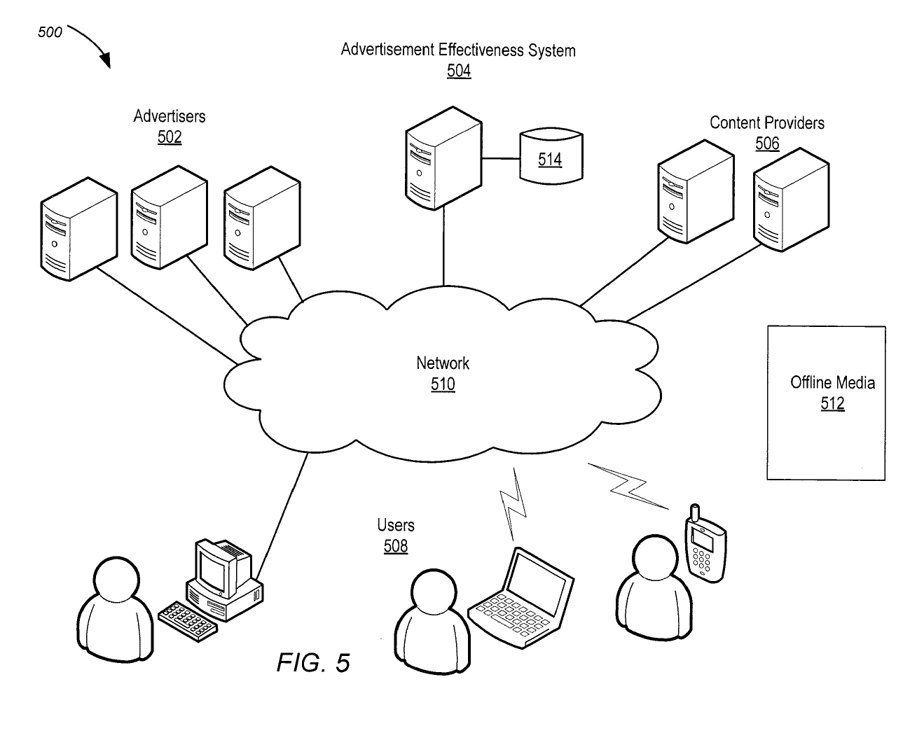

FIG. 5 is a block diagram of an example advertising system 500. The advertising system 500 includes advertisers 502, advertisement effectiveness system 504, content providers 506, and users 508. Each of these entities can be coupled to a network 510 (e.g., the Internet) using one or more communication channels (e.g., wireless, optical, Ethernet). The advertising system 500 also includes offline media 512. The offline media 512 includes, for example, advertisements presented in television and radio broadcasts. The advertisements presented by offline media 512 can be monitored by advertisement effectiveness system 504.

In some implementations, the advertisement effectiveness system 504 is an advertisement serving program run by an advertisement network service provider. Website owners can enroll in a program to enable text, image and video advertisements on their sites. These advertisements can be administered by the advertisement effectiveness system 104 and generate revenue e.g., a per-click, per-thousand-impressions, cost-per-action or other basis. User events resulting in presentation of particular advertisements are used by the advertisement effectiveness system 504 to determine the effectiveness of advertisements. In some implementations, the advertisement effectiveness system 504 utilizes search technology to serve advertisements based on website content, the user's geographical location, and other factors such as search results or user provided keywords. The advertisement effectiveness system 504 can provide an online environment with user interfaces for facilitating interaction between advertisers 502, content providers 506 and users 508. The advertisement effectiveness system 504 is operatively coupled to a storage device 514 for storing information associated with advertisement effectiveness.

The various aspects of the subject matter described in this specification and all of the functional operations described in this specification can be implemented in digital electronic circuitry, or in computer software, firmware, or hardware, including the structures disclosed in this specification and their structural equivalents, or in combinations of one or more of them. The subject matter described in this specification can be implemented as one or more computer program products, i.e., one or more modules of computer program instructions encoded on a computer-readable medium for execution by, or to control the operation of, data processing apparatus. The instructions can be organized into modules in different numbers and combinations from the exemplary modules described. The computer-readable medium can be a machine-readable storage device, a machine-readable storage substrate, a memory device, a composition of matter effecting a machine-readable propagated signal, or a combination of one or more them. The term “data processing apparatus” encompasses all apparatus, devices, and machines for processing data, including by way of example a programmable processor, a computer, or multiple processors or computers. The apparatus can include, in addition to hardware, code that creates an execution environment for the computer program in question, e.g., code that constitutes processor firmware, a protocol stack, a database management system, an operating system, or a combination of one or more of them. A propagated signal is an artificially generated signal, e.g., a machine-generated electrical, optical, or electromagnetic signal, that is generated to encode information for transmission to suitable receiver apparatus.

A computer program (also known as a program, software, software application, script, or code) can be written in any form of programming language, including compiled or interpreted languages, and it can be deployed in any form, including as a stand-alone program or as a module, component, subroutine, or other unit suitable for use in a computing environment. A computer program does not necessarily correspond to a file in a file system. A program can be stored in a portion of a file that holds other programs or data (e.g., one or more scripts stored in a markup language document), in a single file dedicated to the program in question, or in multiple coordinated files (e.g., files that store one or more modules, sub-programs, or portions of code). A computer program can be deployed to be executed on one computer or on multiple computers that are located at one site or distributed across multiple sites and interconnected by a communication network.

The processes and logic flows described in this specification can be performed by one or more programmable processors executing one or more computer programs to perform functions by operating on input data and generating output. The processes and logic flows can also be performed by, and apparatus can also be implemented as, special purpose logic circuitry, e.g., an FPGA (field programmable gate array) or an ASIC (application-specific integrated circuit).

Processors suitable for the execution of a computer program include, by way of example, both general and special purpose microprocessors, and any one or more processors of any kind of digital computer. Generally, a processor will receive instructions and data from a read-only memory or a random access memory or both. The essential elements of a computer are a processor for performing instructions and one or more memory devices for storing instructions and data. Generally, a computer will also include, or be operatively coupled to receive data from or transfer data to, or both, one or more mass storage devices for storing data, e.g., magnetic, magneto-optical disks, or optical disks. However, a computer need not have such devices. Moreover, a computer can be embedded in another device, e.g., a mobile telephone, a personal digital assistant (PDA), a mobile audio player, a Global Positioning System (GPS) receiver, to name just a few. Computer-readable media suitable for storing computer program instructions and data include all forms of non-volatile memory, media and memory devices, including by way of example semiconductor memory devices, e.g., EPROM, EEPROM, and flash memory devices; magnetic disks, e.g., internal hard disks or removable disks; magneto-optical disks; and CD-ROM and DVD-ROM disks. The processor and the memory can be supplemented by, or incorporated in, special purpose logic circuitry.

To provide for interaction with a user, the subject matter described in this specification can be implemented on a computer having a display device, e.g., a CRT (cathode ray tube) or LCD (liquid crystal display) monitor, for displaying information to the user and a keyboard and a pointing device, e.g., a mouse or a trackball, by which the user can provide input to the computer. Other kinds of devices can be used to provide for interaction with a user as well; for example, feedback provided to the user can be any form of sensory feedback, e.g., visual feedback, auditory feedback, or tactile feedback; and input from the user can be received in any form, including acoustic, speech, or tactile input.

Various aspects of the subject matter described in this specification can be implemented in a computing system that includes a back-end component, e.g., as a data server, or that includes a middleware component, e.g., an application server, or that includes a front-end component, e.g., a client computer having a graphical user interface or a Web browser through which a user can interact with an implementation of the subject matter described in this specification, or any combination of one or more such back-end, middleware, or front-end components. The components of the system can be interconnected by any form or medium of digital data communication, e.g., a communication network. Examples of communication networks include a local area network (“LAN”) and a wide area network (“WAN”), e.g., the Internet.

The computing system can include clients and servers. A client and server are generally remote from each other and typically interact through a communication network. The relationship of client and server arises by virtue of computer programs running on the respective computers and having a client-server relationship to each other.

While this specification contains many specifics, these should not be construed as limitations on the scope of what may be claimed, but rather as descriptions of features specific to particular implementations of the subject matter. Certain features that are described in this specification in the context of separate embodiments can also be implemented in combination in a single embodiment. Conversely, various features that are described in the context of a single embodiment can also be implemented in multiple embodiments separately or in any suitable subcombination. Moreover, although features may be described above as acting in certain combinations and even initially claimed as such, one or more features from a claimed combination can in some cases be excised from the combination, and the claimed combination may be directed to a subcombination or variation of a subcombination.

Similarly, while operations are depicted in the drawings in a particular order, this should not be understood as requiring that such operations be performed in the particular order shown or in sequential order, or that all illustrated operations be performed, to achieve desirable results. In certain circumstances, multitasking and parallel processing may be advantageous. Moreover, the separation of various system components in the embodiments described above should not be understood as requiring such separation in all embodiments, and it should be understood that the described program components and systems can generally be integrated together in a single software product or packaged into multiple software products.

The subject matter of this specification has been described in terms of particular embodiments, but other embodiments can be implemented and are within the scope of the following claims. For example, the actions recited in the claims can be performed in a different order and still achieve desirable results. As one example, the processes depicted in the accompanying figures do not necessarily require the particular order shown, or sequential order, to achieve desirable results. In certain implementations, multitasking and parallel processing may be advantageous. Other variations are within the scope of the following claims.

What is claimed is:

1. A method comprising:
identifying a plurality of user events, where each user event is a tracked online activity or action;
identifying information associated with each identified user event, the information including a time and a location of each user event;
associating each user event with an advertisement including relating each advertisement with times and locations of associated user events; and
determining advertisement effectiveness using the information from the identified plurality of user events.

2. The method of claim 1, where the user events include a search query.

3. The method of claim 1, where the user events include advertisement impressions.

4. The method of claim 1, where the user events include a user selection of a presented advertisement.

5. The method of claim 1, where the user events include user input to a telephone.

6. The method of claim 1, where identifying a user location includes:
identifying an Internet Protocol address associated with the user; and
determining a location associated with the Internet Protocol address.

7. The method of claim 1, where associating a user event with an advertisement includes identifying one or more keywords associated with the advertisement that match a search query user event.

8. The method of claim 1, where determining advertising effectiveness includes comparing a frequency of advertisement presentations associated with user events with the location of the user events.

9. The method of claim 1, where determining advertising effectiveness includes comparing a frequency of advertisement presentations associated with user events with the time of the user events.

10. The method of claim 1, where determining advertising effectiveness includes identifying keywords that result in a greater number of user events than other keywords.

11. The method of claim 1, further comprising:
generating a report identifying presentations of a particular advertisement with respect to location and time.

12. The method of claim 1, where determining advertising effectiveness includes, for particular locations, comparing occurrences of an advertisement impression with a selection of the advertisement.

13. A computer program product, encoded on a computer-readable medium, operable to cause data processing apparatus to perform operations comprising:
identifying a plurality of user events, where each user event is a tracked online activity or action;
identifying information associated with each identified user event, the information including a time and a location of each user event;
associating each user event with an advertisement including relating each advertisement with times and locations of associated user events; and
determining advertisement effectiveness using the information from the identified plurality of user events.

14. A method comprising:
collecting data from online user events, the user event data including a time of each user event, where each user event is a tracked online activity or action;
receiving advertisement data identifying an advertisement in offline media, the advertisement data including a respective time when the advertisement was presented; and
determining an effectiveness of one or more advertisements using the user event data and the advertisement data.

15. The method of claim 14, where collecting data from online user events further comprises identifying a location of the user.

16. The method of claim 14, where receiving advertisement data identifying advertisements comprises monitoring television transmissions.

17. The method of claim 16, where monitoring television transmissions includes monitoring closed captioning streams.

18. The method of claim 17, where monitoring closed captioning streams comprises identifying keywords in the closed captioning stream associated with an advertisement.

19. The method of claim 14, where receiving advertisement data identifying advertisements includes identifying radio advertisements.

20. The method of claim 14, where receiving advertisement data further comprises identifying a location of the advertisement transmission.

21. The method of claim 20, where the location is a particular Designated Television Market Area.

22. The method of claim 13, where the determining effectiveness of an advertisement includes comparing the presentation times of an advertisement with the user events associated with the advertisement.

23. The method of claim 13, where determining effectiveness of an advertisement includes identifying an increase in user events related to the presentation of the advertisement.

24. The method of claim 22, where the user events are within the same location as the presentation of the advertisement.

25. The method of claim 13, where determining effectiveness of an advertisement includes comparing the relative user events associated with the presentation of different test advertisements.

26. A computer program product, encoded on a computer-readable medium, operable to cause data processing apparatus to perform operations comprising:
collecting data from online user events, the user event data including a time of each user event, where each user event is a tracked online activity or action;
receiving advertisement data identifying an advertisement in offline media, the advertisement data including a respective time when the advertisement was presented; and
determining an effectiveness of one or more advertisements using the user event data and the advertisement data.

27. A system comprising:
means for identifying a plurality of user events, where each user event is a tracked online activity or action;
means for identifying information associated with each identified user event, the information including a time and a location of each user event;
means for associating each user event with an advertisement including relating each advertisement with times and locations of associated user events; and
means for determining advertisement effectiveness using the information from the identified plurality of user events.

28. A system comprising:
means for collecting data from online user events, the user event data including a time of each user event, where each user event is a tracked online activity or action;
means for identifying advertisements in offline media;
means for collecting advertisement data from the identified advertisements, the advertisement data including a time when the advertisement was presented;
means for comparing the user event data with the advertisement data; and
means for determining an effectiveness of one or more advertisements using the user event data.
